(19) United States
(12) Patent Application Publication
(10) Pub. No.: US 2014/0355519 A1
(43) Pub. Date: Dec. 4, 2014

(54) SHARING WIRELESS TRAFFIC

(71) Applicant: International Business Machines Corporation, Armonk, NY (US)

(72) Inventors: Chang Feng Li, Beijing (CN); Xing Xing Shen, Beiging (CN); Yun Wang, Beijing (CN); Ding Guo Wang, Beijing (CN); Yu Jie Zhao, Beijing (CN)

(73) Assignee: International Business Machines Corporation, Armonk, NY (US)

(21) Appl. No.: 14/259,348

(22) Filed: Apr. 23, 2014

(30) Foreign Application Priority Data
May 31, 2013 (CN) 201310213929.8

(51) Int. Cl. H04W 28/02; H04W 60/00

(52) U.S. Cl. CPC H04W 28/0215; H04W 60/00
USPC 370/328

(57) ABSTRACT

The invention discloses a method and system for sharing wireless traffic, the method comprising: receiving a request for sharing the wireless traffic from a requesting mobile device, the request containing a list of unique numbers of other mobile devices within a certain range of distance from the requesting mobile device; selecting, for the requesting mobile device, at least one mobile device for sharing the wireless traffic from the received list; and sending, to the requesting mobile device, the unique number of the at least one selected mobile device and its connection channel password. By virtue of the method and apparatus according to the embodiments of the present invention, traffic can be shared among mobile devices' users without participation of mobile operators, thereby saving money for the users.

### BACKGROUND

The present disclosure relates to information processing and, more specifically, to a method and apparatus for sharing wireless traffic.

In recent years, introduction of wireless Internet technology has led to a new era in mobile device development. Evolvement of this technology marks the end of an era when people can only access to a network through fixed devices. It now becomes practical to access to the network anywhere and anytime. Therefore, a considerable number of mobile network applications have quickly occupied the market and has become a trend. People use mobile devices to do things that could only be done previously with fixed networking devices, for example, QQ chatting, viewing Wiki, shopping, financial management, etc. Undoubtedly, the mobile Internet technology has, to a certain extent, changed the traditional lifestyle.

However, this new lifestyle also brings some troubles; for example, a great number of wireless Internet applications generate enormous traffic to the wireless network, such that mobile operators have to restrict wireless traffic. The current solution is that the operators either charge subscribers according to their traffic or provide so called packages to subscribers; i.e., providing a fixed monthly traffic to each subscriber under a fixed charge, and the extra traffic is charged relatively high. Most subscribers would select the packages in order to save money. However, the package traffic of some subscribers might not be sufficient temporarily due to particular circumstances, but the extra traffic will be charged relatively high and change of the package will not be effective till next month; therefore, it cannot satisfy the temporary need for the higher traffic. Moreover, since the need is temporary, frequent change of packages is not convenient for subscribers; while some other subscribers have abundant traffic, which would be a waste at the end of a month. For the subscribers as a whole, it is a very uneconomical operating mode.

Existing mobile operators generally issue a warning when a subscriber's traffic approaches to the upper limit of the traffic as specified in the package, but it cannot solve the problem that the subscriber's traffic is temporarily insufficient, and the subscriber has to pay extra money for the access to the network, while those subscribers that have much remaining traffic cannot share their traffic to the abovementioned subscribers. The mobile operators themselves have no intention to solve this problem, because sharing traffic among subscribers would increase the burden on mobile operators' networks, but cannot bring revenues to the mobile operators.

### SUMMARY

Therefore, it is desirable for a solution, which can share network traffic among mobile devices without participation of mobile operators, thereby saving money for subscribers.

According to one aspect of the present disclosure, there is provided a method for sharing wireless traffic, comprising:

receiving a request for sharing the wireless traffic from a requesting mobile device, the request containing a list of unique numbers of other mobile devices within a certain range of distance from the requesting mobile device;

selecting, for the requesting mobile device, at least one mobile device for sharing the wireless traffic from the received list; and

sending, to the requesting mobile device, the unique identification number of the at least one selected mobile device and its connection channel password.

According to another aspect of the present disclosure, there is provided a method for a requesting mobile device to request for sharing wireless traffic, comprising:

sending a request for sharing the wireless traffic, the request containing a list of unique numbers of other mobile devices within a certain range of distance from the requesting mobile device;

receiving the unique number of at least one selected mobile device and its connection channel password;

connecting to the at least one selected mobile device by using the unique number of the at least one selected mobile device and its connection channel password.

According to yet another aspect of the present disclosure, there is provided a system for sharing wireless traffic, comprising:

a receiving unit configured to receive a request for sharing the wireless traffic from a requesting mobile device, the request containing a list of unique numbers of other mobile devices within a certain range of distance from the requesting mobile device;

a selecting unit configured to select, for the requesting mobile device, at least one mobile device for sharing the wireless traffic from the received list; and

a sending unit configured to send, to the requesting mobile device, the unique number of the at least one selected mobile device and its connection channel password.

According to yet another aspect of the present disclosure, there is provided a mobile device requesting sharing wireless traffic, comprising:

a sending unit configured to send a request for sharing the wireless traffic, the request containing a list of unique numbers of other mobile devices within a certain range of distance from the requesting mobile device;

a receiving unit configured to receive the unique number of at least one selected mobile device and its connection channel password;

a connecting unit configured to connect with the at least one selected mobile device by using the unique identification number of the at least one selected mobile device and its connection channel password.

By virtue of the method and apparatus according to the embodiments of the present invention, traffic can be shared among mobile devices' users without participation of mobile operators, thereby saving money for the users.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system/server 12 which is applicable to implement the embodiments of the present disclosure;

FIG. 2 schematically shows a basic network environment in which the embodiments of the present disclosure are applied;

FIG. 3 shows a flow chart of a method for sharing wireless traffic according to one embodiment of the present disclosure;

FIG. 4 shows a flow chart of a method for a requesting mobile device to request sharing wireless traffic according to one embodiment of the present disclosure;

FIG. 5 shows a schematic block diagram of a system for sharing wireless traffic according to one embodiment of the present invention; and

FIG. 6 shows a schematic block diagram of a mobile device requesting for sharing wireless traffic according to one embodiment of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, in some embodiments, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated data signal may take any of a variety of forms including, but not limited to, an electro-magnetic signal, optical signal, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implements the function/act specified in the flowchart and/or block diagram block or blocks.

The computer program instructions may also be loaded onto a computer, other programmable data processing apparatus, or other devices to cause a series of operational steps to be performed on the computer, other programmable data processing apparatus or other devices to produce a computer implemented process such that the instructions which execute on the computer or other programmable apparatus provide processes for implementing the functions/acts specified in the flowchart and/or block diagram block or blocks.

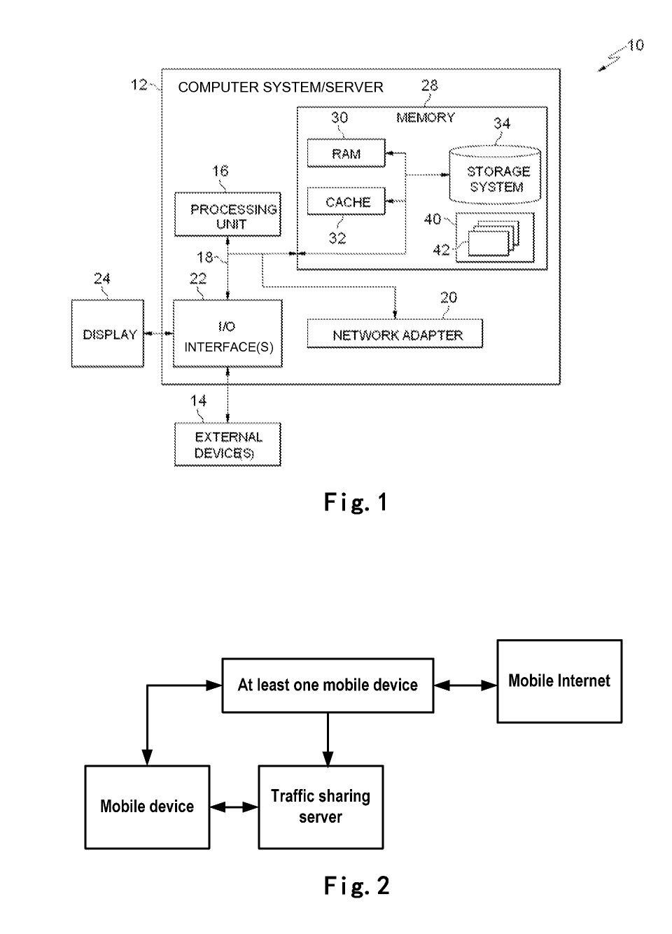

Referring now to FIG. 1, in which a block diagram of an exemplary computer system/server 12 which is applicable to implement the embodiments of the present disclosure is shown. Computer system/server 12 shown in FIG. 1 is only illustrative and is not intended to suggest any limitation as to the scope of use or functionality of embodiments of the invention described herein.

As shown in FIG. 1, computer system/server 12 is represented in the form of a general-purpose computing device. The components of computer system/server 12 may include, but are not limited to, one or more processors or processing units 16, a system memory 28, and a bus 18 that couples various system components, including system memory 28 and processing unit 16.

Bus 18 represents one or more of several types of bus structures, including a memory bus or memory controller, a peripheral bus, an accelerated graphics port, and a processor or local bus using any of a variety of bus architectures. By way of example, and without limitation, such architectures include Industry Standard Architecture (ISA) bus, Micro Channel Architecture (MAC) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 1 and typically called a “hard drive”). Although not shown in FIG. 1, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example. Such program modules 42 include, but are not limited to an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The embodiments of the present disclosure are described in detail with reference to the accompanying drawings and specific examples.

In the embodiments of the present disclosure, a mobile device includes, but not limited to, various devices that can access the world wide web through the mobile Internet, such as a mobile phone, a laptop, etc. FIG. 2 schematically shows a basic network environment in which the embodiments of the present disclosure are applied. A mobile device submits a request for sharing traffic to a traffic sharing server. The traffic sharing server receives registration of the mobile device to thereby manage to which mobile devices the mobile device may submit the request for sharing traffic; and the communication between the traffic sharing server and the registered mobile device may enable the traffic sharing server to know the current remaining traffic of respective mobile devices, etc. The traffic sharing server selects at least one mobile device available for sharing traffic based on the request information and registration information, such that the requesting mobile device may be connected to the selected mobile device and access the wireless Internet with the selected mobile device being as an access point, without involvement of the mobile operator.

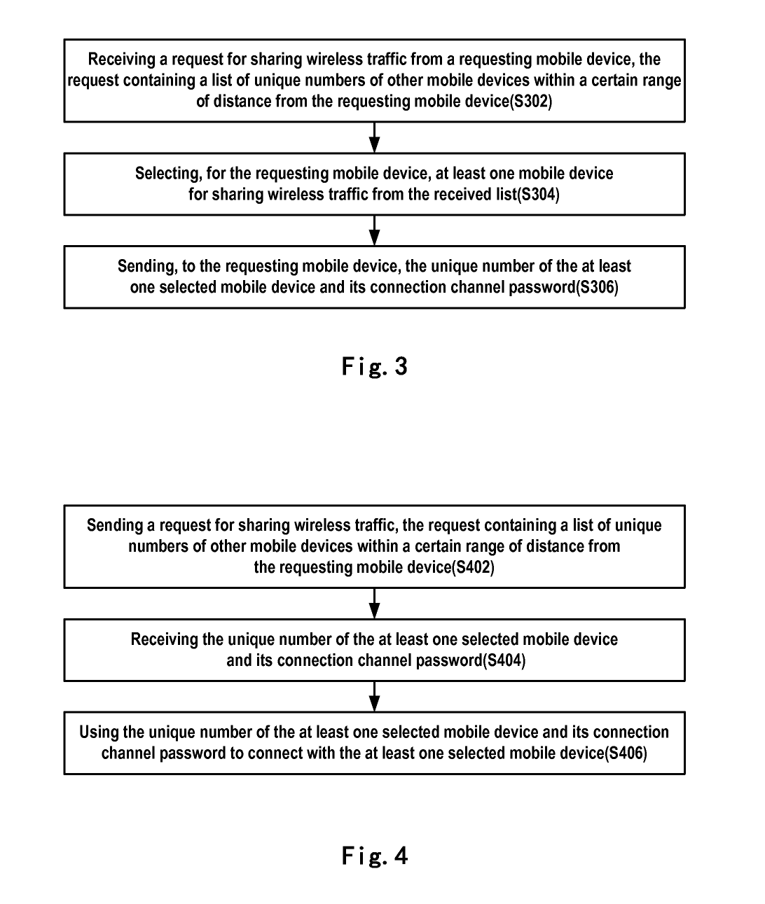

In one embodiment of the present disclosure, a method for sharing wireless traffic as implemented on a sharing server is provided. The method is to be implemented on a traffic sharing server. FIG. 3 shows a flow chart of a method for sharing wireless traffic according to one embodiment of the present disclosure. As shown in FIG. 3, first, at step 302, a request for sharing wireless traffic from a requesting mobile device is received, the request containing a list of unique numbers of other mobile devices within a certain range of distance from the requesting mobile device; at step 304, at least one mobile device for sharing wireless traffic is selected from the received list for the requesting mobile device; at step 306, the unique number of the at least one selected mobile device and its connection channel password are sent to the requesting mobile device.

Specifically, at step 302, the request for sharing the wireless traffic is received from the requesting mobile device, the request containing a list of unique numbers of other mobile devices within a certain range of distance from the requesting mobile device. At present, many technologies can enable a mobile device to sense the surrounding mobile devices, for example, through the WiFi function on the mobile device and taking the requesting mobile device as a slave device, those surrounding mobile devices that have opened the WiFi primary device function can be sensed. The surrounding mobile devices that have opened the Bluetooth function may also be sensed through the Bluetooth technology; or the surrounding mobile devices may also be sensed through the positioning service provided by the wireless operator, and the like. Such requesting mobile device may obtain the unique numbers of other mobile devices within a certain range of distance from the requesting mobile device. For example, when using the WiFi technology, the unique number of the mobile device is a service set identifier (SSID); when using the Bluetooth technology, the unique number is a device number; and when using the positioning service provided by the wireless operator to sense the surrounding mobile devices, the unique number of a mobile device is a SIM card number (for example, a mobile phone number) of the mobile device. The requesting mobile device arranges the unique numbers of all other mobile devices within a certain range of distance from the requesting mobile device into a list that is embedded into the request for sharing wireless traffic, which is sent to the traffic sharing server.

In one embodiment, the request for sharing the wireless traffic from the requesting mobile device further comprises at least one of the following information of the requesting mobile device: a unique number, a size of traffic requested for sharing, a manner for selecting a mobile device for sharing traffic, a manner for sharing traffic, a period of time for sharing traffic, a location of the mobile device when sharing traffic, etc. As to the manner for selecting the mobile device for sharing traffic, if there are a plurality of mobile devices that can be selected by the traffic sharing server, they can be selected one by one according to the order as arranged in the list; they can also be selected according to the remaining traffic of the mobile devices in the list; or they can be selected according to connection signal strength of the mobile devices in the list. Further, the mobile devices can be weighted and then ranked based on the above various information, for example, the remaining traffic of the mobile device, the connection signal strength, being or being not a friend, and the like, so as to determine whether to be selected as the mobile device for traffic sharing. As to the manner for traffic sharing, it means in a traffic sharing request, whether only a single mobile device is selected for traffic sharing or a plurality of mobile devices may be used for traffic sharing, etc. Because some mobile devices have some requirements on the mobile device that is willing to share traffic, in order to meet these requirements, the requesting mobile device has to provide some information. Of course, the above information may also be extended as required. The above information may be directly embedded in a traffic sharing request at once or provided as required by the traffic sharing server.

The request for sharing traffic may be directly sent to the traffic sharing server by the requesting mobile device using an application layer protocol through the wireless Internet, for example, performing data transmission by using http, https protocols; or the traffic sharing server can provide a page, and the user of the requesting mobile device provides relevant information to the traffic sharing server by filling a form, or submits the request for sharing traffic using various other information interacting manners.

In one embodiment, the method further comprises step S301 to receive registration from at least one mobile device, wherein the at least one mobile device is registered as a mobile device for sharing wireless traffic. The objective of the mobile device to register with the traffic sharing server is to promise that the mobile device itself is willing to provide a traffic sharing service, such that other mobile devices can obtain an access password of the mobile device, use this mobile device as the access point of the mobile network, and thereby access the Internet. Preferably, the registration information contains the unique number of the mobile device and a connection channel password. The registration information may further contain some other information, for example, to which devices the traffic sharing service will be provided, specific time for providing the service, and the like. In one embodiment of the registration information, the registered mobile device may demand a mobile device group for sharing traffic; i.e., only providing the traffic sharing service to mobile devices in the mobile device group for sharing traffic. For example, the mobile device group for sharing traffic may be a list of friends of the mobile device's owner, or a set of other reciprocal mobile devices voluntarily offering to share their traffic, or a list of unique numbers of some mobile devices, and the like. The registration information may further comprise the size of traffic available for sharing, the period of time for sharing traffic, the location of the device when traffic is available for sharing, and the like. One or a part of such information may exist in the registration information. In one embodiment, the traffic sharing server stores the unique number of the registered mobile device to a list of unique numbers of the mobile devices available for sharing wireless traffic, and the list of unique numbers may include a plurality of unique numbers of the mobile devices, for example, SSID number, Bluetooth device number, and the like.

Preferably, the requesting mobile device is a registered mobile device. Moreover, in order to enhance the security for use, the registration information may further comprise a password set for the mobile device, and the request from the mobile device for sharing wireless traffic contains the password set for the mobile device. In this way, password verification may be performed upon submitting the request, thereby enhancing the system security.

At step 304, at least one mobile device for sharing wireless traffic is selected for the requesting mobile device from the received list. In one embodiment, the traffic sharing server selects, for the requesting mobile device, at least one device for sharing wireless traffic by matching the received list with the list of stored unique numbers of mobile devices for sharing wireless traffic. For example, when using the WiFi technology, the received list comprises a plurality of nearby mobile devices that can act as the WiFi access points; the traffic sharing server stores a plurality of registered mobile devices available for sharing traffic; therefore, by matching the unique numbers in the two lists, the selected mobile device for sharing traffic can be found. Of course, it is also possible that no available mobile device is found after the matching, a request failure will be returned to the mobile device. Preferably, the reason for failure may also be provided.

In one embodiment, if the registered user has certain requirements on mobile devices that are willing to provide traffic sharing in the registration information, when matching the received list with the list of the stored unique numbers of the mobile devices available for sharing traffic, the information contained in the request for sharing wireless traffic from the mobile device will be matched with the stored registration information of the mobile devices in the list of unique numbers of the mobile devices available for sharing wireless traffic. For example, the period of time for sharing traffic as required in the registration information is 8:00-10:00 am, while the requested time for sharing traffic is 2:00 pm; even if other conditions are satisfied, the mobile device cannot act as the selected mobile device. For another example, if the requesting mobile device does not select the manner for selecting a mobile device for sharing traffic, but the traffic sharing server finds that there may be a plurality of selected mobile devices, then it may send the available list to the requesting mobile device that selects one or more mobile devices therefrom as the mobile device(s) for sharing traffic. In one embodiment, all registration information of the mobile devices in the list of stored unique numbers of mobile devices available for sharing wireless traffic is matched with all information of the requesting mobile device for selection.

At step S306, the unique number of the at least one selected mobile device and its connection channel password are sent to the mobile device. In this way, the requesting mobile device is connected to the at least one selected mobile device in response to receipt of the unique identification number of the at least one selected mobile device and its connection channel password. In one embodiment, the traffic sharing server further sends, to the mobile device, the traffic available for sharing of each mobile device in the current request for the at least one selected mobile device. The traffic available for sharing in the current request is jointly determined by the current remaining traffic of the mobile device and the traffic available for sharing.

Preferably, the requesting mobile device may record the used traffic for sharing and send it to the traffic sharing server, or the selected mobile device may record the used traffic for sharing and send it to the traffic sharing server.

In one embodiment, the requesting mobile device disconnects from the selected one mobile device. At this point, the traffic sharing server will receive the usage amount of the shared traffic of the at least one selected mobile device in this request, such that the traffic sharing server may know how much traffic for sharing is provided by the registered device, and how much available sharing traffic still remains. In one embodiment, after sharing and using the traffic, the registered mobile device should also report its own remaining traffic to the sharing traffic server so as to avoid the circumstance in which it is still appointed as a mobile device for traffic sharing although its own remaining traffic is insufficient to provide traffic sharing. Thus, the traffic sharing server should further consider the stored usage amount of the shared traffic of the mobile device available for sharing wireless traffic when matching the request for sharing wireless traffic from the mobile device with the registration information of the mobile devices in the list of unique numbers of the mobile devices available for sharing wireless traffic.

In one embodiment, since the traffic sharing request is generally once-for-all, the connection channel password information of the selected mobile device may be channel password information temporarily generated by the traffic sharing server, which is different from the commonly used connection channel password information of the selected mobile device. The traffic sharing server may maintain the mapping relationship between the passwords and notify the generated connection channel password to the selected mobile device for traffic sharing. When receiving a request for accessing the Internet by using the connection channel password information, the selected mobile device for traffic sharing would map the connection channel password information to its real connection channel password based on the above password mapping relationship, thereby allowing for connection. In another embodiment, the traffic sharing server may generate a connection password for the registered mobile device regularly, and update it regularly, such that access is allowed when the selected mobile device receives the connection request, which may also achieve the objective of security.

The traffic sharing server may maintain traffic requesting conditions among respective mobile devices, traffic sharing situations, registration information of mobile devices, a list of mobile devices available for sharing traffic, and other information. The above information may be stored in a database or in other manners.

The requesting mobile device and the selected mobile device may be present in the mobile operation network of a same mobile operator or not in the mobile operation network of the same mobile operator, as long as the mobile devices may sense the location of the other party and may act as the network access points. The specific technical solution for sharing is similar to the traffic sharing between the mobile devices of the same mobile operator.

Based on the same inventive concept, the embodiments of the present disclosure further disclose a method of a requesting mobile device for requesting sharing wireless traffic. The method is to be implemented on the requesting mobile device. FIG. 4 shows a flow chart of a method for a requesting mobile device to request sharing wireless traffic according to one embodiment of the present invention. As shown in FIG. 4, at step 402, a request for sharing wireless traffic is sent, the request containing a list of unique numbers of other mobile device within a certain range of distance from the requesting mobile device; at step 404, the unique number of the at least one selected mobile device and its connection channel password are received; at step S406, the at least one selected mobile device is connected by using the unique number of the at least one selected mobile device and its connection channel password. In this embodiment, step S402 and step S404 correspond to step S302 and step S306 in FIG. 3 in interacting systems and devices.

In one embodiment, the requesting mobile device should further get other mobile devices within a certain range of distance from the requesting mobile device. For example, the selected mobile device acts as the WiFi primary device, then the requesting mobile device may request for connecting with a mobile device whose SSID number is the received unique number. Through the connection channel password, the selected mobile device acts as the WiFi access point to access the Internet. For another example, the selected mobile device acts as a Bluetooth device, then the requesting mobile device may request for connecting with a Bluetooth mobile device whose device number is the received unique number. Through the connection channel password, the Internet is accessed.

In one embodiment, when the requesting mobile device is using the shared traffic, if the mobile device for sharing its traffic is leaving, the connection strength between the requesting mobile device and the mobile device providing the service will become increasingly weaker, and when the weakness reaches a certain extent, the requesting mobile device can not access the Internet, and the connection will be disconnected. In other words, the requesting mobile device disconnects from the at least one selected mobile device in response to the connection strength with the at least one selected mobile device being lower than a set threshold. The set threshold may be set by the requesting mobile device, for example, 75% of the connection strength. The specific value is dependent on the specific connection strength under which the data transmission for the requesting mobile device is stable.

In another embodiment, receiving the unique number of the at least one selected mobile device and its connection channel password further comprises: receiving the traffic available for sharing of each selected mobile device in the current request for the at least one selected mobile device, and the method further comprises: the mobile device disconnecting from the selected one mobile device in response to the used traffic for sharing reaches the traffic available for sharing of a mobile device in the current request for the at least one selected mobile device.

In one embodiment, in response to the number of the at least one selected mobile device being more than one, after the mobile device disconnects one of the selected mobile devices, it connects with the next selected mobile device. In this way, it may continuously use a plurality of selected traffic-sharing mobile devices; moreover, for a requesting mobile device, such handover may be transparent, and the user of the requesting mobile device can barely sense it. If all of the selected mobile devices in one request have been disconnected, while the requesting mobile device still has a request for sharing traffic, it may initiate another request for sharing traffic to the traffic sharing server.

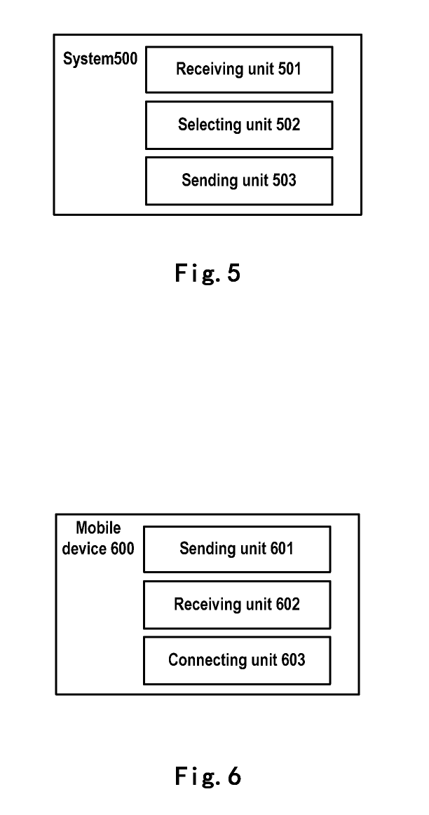

Based on the same inventive concept, embodiments of the present disclosure further provide a system for sharing wireless traffic. FIG. 5 shows a schematic block diagram of a system for sharing wireless traffic according to one embodiment of the present invention. In FIG. 5, the apparatus is generally denoted as 400. As shown in the figure, the system 400 for sharing wireless traffic comprises: a receiving unit 501 configured to receive a request for sharing wireless traffic from a requesting mobile device, the request containing a list of unique numbers of other mobile devices within a certain range of distance from the requesting mobile device; a selecting unit 502 configured to select, for the requesting mobile device, at least one mobile device for sharing wireless traffic from the received list; and a sending unit 503 configured to send, to the requesting mobile device, the unique number of the at least one selected mobile device and its connection channel password.

According to one embodiment, the system 400 further comprises a registering unit (not shown in FIG. 5) that is configured to receive registration from at least one mobile device, wherein the at least one mobile device to be registered is registered as a mobile device for sharing wireless traffic, and wherein the registration information includes the unique number of the mobile device and its connection channel password.

According to one embodiment, the system 400 further comprises a storing unit (not shown in FIG. 5) configured to store the unique number of the registered mobile device into a list of unique numbers of mobile devices available for sharing wireless traffic.

In one embodiment, the selecting unit comprises a matching unit configured to match the received list with the list of stored unique numbers of mobile devices available for sharing wireless traffic to thereby select, for the requesting mobile device, at least one mobile device for sharing wireless traffic.

According to one embodiment, the registration information further comprises at least one of the following information registered by the registered mobile device: a list of mobile devices available for sharing traffic, a size of traffic available for sharing, a period of time available for sharing traffic, a location of the mobile device when traffic is available for sharing. The request from the requesting mobile device for sharing wireless traffic further comprises at least one of the following information of the requesting mobile device: the unique number, a size of traffic requested for sharing, a manner for selecting a mobile device for sharing traffic, a manner for sharing traffic, a period of time for sharing traffic, and a location of the mobile device when sharing traffic; and wherein the matching unit is further configured to match the information contained in the request for sharing wireless traffic from the requesting mobile device with the stored registration information of the mobile devices in the list of unique numbers of the mobile devices available for sharing wireless traffic.

According to one embodiment, the sending unit is further configured to send, to the requesting mobile device, the traffic available for sharing of each selected mobile device in the current request of the at least one selected mobile device.

According to one embodiment, the receiving unit is further configured to in response to the requesting mobile device being disconnected from the at least one selected mobile device, receive the usage amount of the shared traffic of the at least one selected mobile device in the request; wherein the matching unit considers the stored usage amount of the shared traffic of the mobile device available for sharing wireless traffic when matching the request for sharing wireless traffic from the requesting mobile device with the registration information of the mobile devices in the list of unique numbers of the mobile devices available for sharing wireless traffic.

Based on the same inventive concept, embodiments of the present disclosure further provide a mobile device requesting for sharing wireless traffic. FIG. 6 shows a schematic block diagram of a mobile device requesting for sharing wireless traffic according to one embodiment of the present disclosure. In FIG. 6, the mobile device is generally denoted as 600. As shown in the figure, the mobile device 600 comprises: a sending unit 601 configured to send a request for sharing wireless traffic, the request containing a list of unique numbers of other mobile devices within a certain range of distance from the requesting mobile device; a receiving unit 602 configured to receive the unique number of at least one selected mobile device and its connection channel password; a connecting unit 603 configured to connect with the at least one selected mobile device by using the unique number of the at least one selected mobile device and its connection channel password.

In one embodiment, the mobile device 600 further comprises: a disconnecting unit 604 (not shown in FIG. 6) configured to disconnect from the at least one selected mobile device in response to the connection strength with the at least one selected mobile device being lower than a set threshold.

In one embodiment, the receiving unit is further configured to receive the traffic available for sharing of each mobile device in the current request for the at least one selected mobile device, and the mobile device 600 further comprises: a disconnecting unit (not shown in FIG. 6) configured to disconnect from the selected mobile device in response to the used traffic for sharing reaches the traffic available for sharing of one mobile device in the current request for the at least one selected mobile device.

In one embodiment, the mobile device 600 further comprises a connection continuing unit (not shown in FIG. 6) configured to connect with a next selected mobile device after disconnecting from the selected mobile device in response to the number of the at least one selected mobile device being more than one.

As for the specific implementations of the system for sharing wireless traffic and the requesting mobile device, references can be made to the previous depictions of the methods in combination with specific examples, which will not be detailed here.

By virtue of the methods and apparatuses according to the embodiments of the present invention, wireless traffic can be shared among mobile devices without participation of mobile operators, thereby saving money for mobile users.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for sharing wireless traffic, comprising:
receiving a request for sharing the wireless traffic from a requesting mobile device, the request containing a list of unique numbers of other mobile devices within a certain range of distance from the requesting mobile device;
selecting, for the requesting mobile device, at least one mobile device for sharing the wireless traffic from the received list; and
sending, to the requesting mobile device, the unique number of the at least one selected mobile device and its connection channel password.

2. The method according to claim 1, wherein before the step of selecting, for the requesting mobile device, at least one mobile device for sharing the wireless traffic from the received list, the method further comprises:
receiving registration from at least one mobile device, wherein the at least one mobile device to be registered is registered as a mobile device for sharing the wireless traffic; and
wherein registration information comprises the unique number of the registered mobile device and its connection channel password.

3. The method according to claim 2, the method further comprises: storing the unique number of the registered mobile device into a list of unique numbers of mobile devices available for sharing the wireless traffic.

4. The method according to claim 3, wherein selecting, for the requesting mobile device, at least one mobile device for sharing the wireless traffic from the received list comprises: matching the received list with the list of the stored unique numbers of the mobile devices available for sharing the wireless traffic, so as to select the at least one mobile device for sharing the wireless traffic for the requesting mobile device.

5. The method according to claim 3, wherein the registration information further comprises at least one of the following information registered by the registered mobile device: a mobile device group for sharing traffic, a size of traffic available for sharing, a period of time available for sharing traffic, a location of the mobile device when the traffic is available for sharing;
the request for sharing the wireless traffic from the requesting mobile device further comprises at least one of the following information of the requesting mobile device: the unique number, a size of traffic requested for sharing, a manner for selecting a mobile device for sharing traffic, a manner for sharing traffic, a period of time for sharing traffic, and a location of the mobile device for sharing traffic; and
wherein matching the received list with the list of the stored unique numbers of the mobile devices available for sharing the wireless traffic further comprises: matching the information contained in the request for sharing the wireless traffic from the requesting mobile device with the registration information of the mobile devices in the list of the stored unique numbers of the mobile devices available for sharing the wireless traffic.

6. The method according to claim 1, wherein sending, to the requesting mobile device, the unique number of the at least one selected mobile device and its connection channel password further comprises: sending, to the requesting mobile device, the traffic available for sharing of each selected mobile device in the current request for the at least one selected mobile device.

7. The method according to claim 1, further comprising:
in response to the requesting mobile device disconnecting from the at least one selected mobile device, receiving usage amount of the shared traffic of the at least one selected mobile device in the request;
wherein the stored usage amount of the shared traffic of the mobile device available for sharing the wireless traffic is considered when matching the request for sharing the wireless traffic from the requesting mobile device with the registration information of the mobile devices in the list of the stored unique numbers of the mobile devices available for sharing the wireless traffic.

8. A system for sharing wireless traffic, comprising:
a receiving unit configured to receive a request for sharing the wireless traffic from a requesting mobile device, the request containing a list of unique numbers of other mobile devices within a certain range of distance from the requesting mobile device;
a selecting unit configured to select, for the requesting mobile device, at least one mobile device for sharing the wireless traffic from the received list; and
a sending unit configured to send, to the requesting mobile device, the unique number of the at least one selected mobile device and its connection channel password.

9. The system according to claim 8, further comprising:
a registering unit configured to receive registration from at least one mobile device, wherein the at least one mobile device to be registered is registered as a mobile device for sharing the wireless traffic;
wherein registration information comprises the unique number of the registered mobile device and its connection channel password.

10. The system according to claim 9, further comprising: a storing unit configured to store the unique number of the registered mobile device into a list of unique numbers of mobile devices available for sharing the wireless traffic.

11. The system according to claim 10, wherein the selecting unit comprises:
a matching unit configured to match the received list with the list of the stored unique numbers of mobile devices available for sharing the wireless traffic to thereby select, for the requesting mobile device, the at least one device for sharing the wireless traffic.

12. The system according to claim 11, wherein the registration information further comprises at least one of the following information registered by the registered mobile device: a list of mobile devices available for sharing traffic, a size of traffic available for sharing, a period of time available for sharing traffic, a location of the mobile device when the traffic is available for sharing;
the request for sharing the wireless traffic from the requesting mobile device further comprises at least one of the following information of the requesting mobile device: the unique number, a size of traffic requested for sharing, a manner for selecting a mobile device for sharing traffic, a manner of sharing traffic, a period of time for sharing traffic, and a location of the mobile device for sharing traffic; and
wherein the matching unit is further configured to match the information contained in the request for sharing the wireless traffic from the requesting mobile device with the stored registration information of the mobile devices in the list of unique numbers of the mobile devices available for sharing the wireless traffic.

13. A mobile device for requesting for sharing wireless traffic, comprising:
a sending unit configured to send a request for sharing the wireless traffic, the request containing a list of unique numbers of other mobile devices within a certain range of distance from the requesting mobile device;
a receiving unit configured to receive the unique number of at least one selected mobile device and its connection channel password; and
a connecting unit configured to connect with the at least one selected mobile device by using the unique number of the at least one selected mobile device and its connection channel password.

14. The mobile device according to claim 13, further comprises: a disconnecting unit configured to disconnect from the at least one selected mobile device in response to connection strength with the at least one selected mobile device being lower than a set threshold.

15. The mobile device according to claim 13, wherein the receiving unit is further configured to receive the traffic available for sharing of each mobile device in the current request for the at least one selected mobile device, and the mobile device further comprises: a disconnecting unit configured to disconnect from the selected mobile device in response to the usage of the shared traffic reaching the traffic available for sharing of a mobile device in the current request for the at least one selected mobile device.

16. The mobile device according to claim 13, wherein it further comprises: a connection continuing unit configured to, in response to a number of the at least one selected mobile device being more than one, connect with a next selected mobile device after disconnecting from the selected mobile device.
